(19) United States
(12) Patent Application Publication
(10) Pub. No.: US 2013/0014829 A1
(43) Pub. Date: Jan. 17, 2013

(54) Removable Cutting/Welding Torch Cutting Tip Insert

(71) Applicant: Charles Mark Langley, Diamondville, WY (US)

(72) Inventor: Charles Mark Langley, Diamondville, WY (US)

(21) Appl. No.: 13/352,710

(22) Filed: Jan. 18, 2012

Related U.S. Application Data
(60) Provisional application No. 61/434,128, filed on Jan. 19, 2011.

(51) Int. Cl. F15C 1/16

(52) U.S. Cl. 137/13; 137/808

(57) ABSTRACT

Disclosed is a removable device to be inserted into the center hole of the cutting tip of a cutting/welding torch that can be easily cleaned without distorting future cuts, minimizes the amount of oxygen needed for a cutting or welding task, concentrates, controls and defines the flow of air and oxygen into a cutting/welding torch, prevents the center hole of a cutting/welding torch from becoming distorted and imprecise over time, improves the quality of a cut, and minimizes the amount of cut steel that must be cleaned up after a cutting/welding task is completed.

### CROSS REFERENCE TO RELATED APPLICATIONS

The present invention claims the benefit of U.S. Provisional Application Ser. No. 61/434,128, filed 19 JAN. 2011, entitled “Cutting/Welding Torch Cutting Tip Insert” by Charles Mark Langley.

### BACKGROUND OF THE INVENTION

a. Field of the Invention

The present invention generally pertains to cutting/welding torches and more particularly to devices that affect the output of cutting/welding torches.

b. Description of the Background

The outer holes of the cutting tip of a cutting/welding torch use a mixture of highly combustible gas (such as acetylene), oxygen and air to create a flame that is high enough to superheat steel. After the steel is superheated, air and oxygen are discharged through the center hole of the cutting tip to blow away the superheated steel and create a cut. Because the oxygen discharged is obtained from pressurized cylinders, it would be economical to minimize the amount of oxygen needed to complete a cutting or welding task.

When a cutting tip is new, the center hole of the cutting tip has a smooth inner surface and accepts air into the cutting/welding torch without controlling the flow of air in any way. Over time, however, the uncontrolled air flow may affect the cutting tip and cause the center hole of the cutting tip to become dirty, distorted and imprecise. This dirt, distortion and imprecision may affect the quality of a cut and eventually cause the cutting tip to be discarded.

The center hole of a cutting tip is also distorted whenever the cutting tip is cleaned with a tip cleaner because a tip cleaner has rough edges like a file. Experience shows that once a cutting tip is cleaned, it never makes a perfect cut again. Even though cutting tips are designed to be both disposable and replaceable, it would be economical to minimize the number of new cutting tips needed to complete a task.

When a cutting/welding task is complete, the steel cut during the process must be cleaned up. It would thus be advantageous to minimize the amount of cut steel that must be cleaned up.

It would therefore be advantageous to have a removable device that may be inserted into the center hole of the cutting tip of a cutting/welding torch. Such a removable device may be easily cleaned without distorting future cuts, may minimize the amount of oxygen needed for a cutting or welding task, may control and define the flow of air into a cutting/welding torch, may prevent the center hole of a cutting/welding torch from becoming distorted and imprecise over time, may improve the quality of a cut, and may minimize the amount of cut steel that must be cleaned up after a cutting/welding task is completed.

### SUMMARY OF THE INVENTION

The present invention overcomes the disadvantages and limitations of the prior art by providing a removable device that can be inserted into the center hole of the cutting tip of a cutting/welding torch. The present invention can be easily cleaned without distorting future cuts, minimizes the amount of air needed for a cutting or welding task, concentrates, controls and defines the flow of air into a cutting/welding torch, prevents the center hole of a cutting/welding torch from becoming distorted and imprecise over time, improves the quality of a cut, and minimizes the amount of cut steel that must be cleaned up after a cutting/welding task is completed.

The present invention may therefore comprise a method of concentrating, controlling and defining the flow of air and oxygen into a cutting/welding torch. This method may comprise the insertion of a removable device into the center hole of the cutting tip of the cutting/welding torch to concentrate, control and define the flow of air and oxygen into the cutting/welding torch. This removable device may be metallic, may have one flat end to facilitate insertion and removal of the removable device into or out of the center hole of the cutting/welding torch, and may have one end that is neither flat nor straight to concentrate, control and define the flow of air and oxygen into the cutting/welding torch. The end that is neither flat nor straight may have at least one twist, turn or bend or may be shaped like a corkscrew.

The present invention may also comprise a removable device that concentrates, controls and defines the flow of air and oxygen into a cutting/welding torch. This removable device may be inserted into the center hole of the cutting tip of a cutting/welding torch to concentrate, control and define the flow of air into the cutting/welding torch. This removable device may be metallic, may have one flat end to facilitate insertion and removal of the removable device into or out of the center hole of the cutting/welding torch, and may have one end that is neither flat nor straight that concentrates, controls and defines the flow of air and oxygen into the cutting/welding torch. The end that is neither flat nor straight may have at least one twist, turn or bend or may be shaped like a corkscrew.

The advantages of the present invention are: easy cleaning of a cutting tip without distorting future cuts, minimization of the amount of oxygen needed for a cutting or welding task, the concentrating, controlling and defining of the flow of air and oxygen into a cutting/welding torch, the prevention of damage to the center hole of a cutting/welding torch, improved quality of cuts created by a cutting/welding torch, and minimization of the amount of cut steel that must be cleaned up after a cutting/welding task is completed.

### BRIEF DESCRIPTION OF THE DRAWINGS

In the drawings,

FIG. 1 illustrates one embodiment of the present invention.

### DETAILED DESCRIPTION OF THE INVENTION

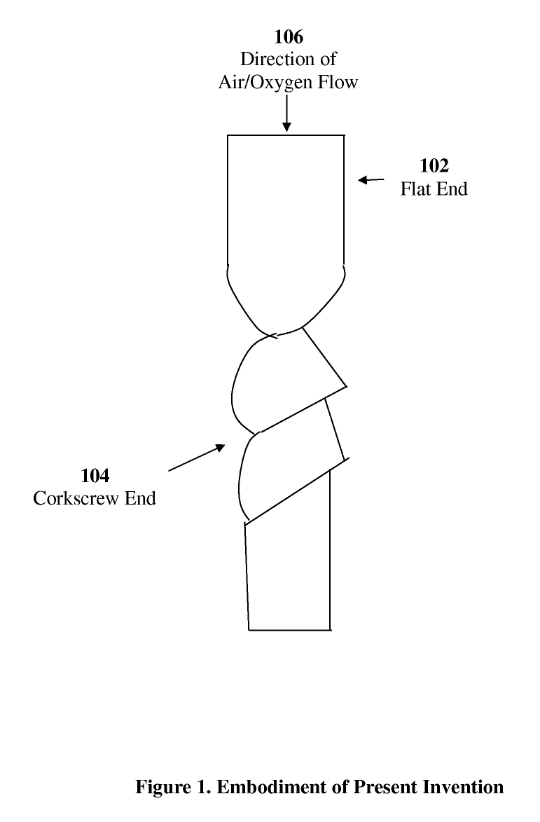

FIG. 1 illustrates one embodiment of the present invention. In this embodiment, the present invention is a metallic piece that has one flat end 102 and one end 104 that is shaped like a corkscrew. When the present invention is inserted into the center hole of the cutting tip of a cutting/welding torch, the flow of air and oxygen 106 into the cutting tip of the cutting/welding torch is converted into a spinning vortex or “tornado.” The action of the present invention thus concentrates, defines and controls the flow of air and oxygen 106 to the cutting/welding torch, allowing for a more precise cut.

The inventor's experience in workplace cutting and welding with the present invention indicates that the present invention reduces the amount of oxygen needed to complete a given cutting/welding task by as much as 50%. This reduces the number of oxygen cylinders needed to complete a given cutting/welding task and minimizes total cost of the task.

The inventor's experience in workplace cutting and welding with the present invention also indicates that cutting tips previously discarded for imprecise cutting may be re-used with the present invention without a drop-off in quality of cut or weld. Even though cutting tips are designed to be both disposable and replaceable, it is economical to re-use discarded cutting tips when possible.

When welding is complete, the present invention minimizes the amount of cut steel that must be cleaned up. The present invention may be easily removed from the cutting/welding torch by gripping the flat end 102 with pliers, allowing the present invention to be cleaned and inserted (after cleaning) into another cutting/welding torch. The present invention keeps the cutting tip from getting dirty enough to require a tip cleaner; thus, the cutting tip is preserved from the damage caused by a tip cleaner that may create distortion and imprecision in future cuts.

Alternate embodiments of the present invention may change the parameters of the present invention, including (but not limited to): the length of either the flat end 102 or the corkscrew end 104, the number of twists, turns and/or bends in the corkscrew end 104, the diameter of the present invention (to allow its insertion into different-sized cutting tips), and different shapes of the twists in the corkscrew end 104 that affect the flow of air and oxygen 106, including non-corkscrew shapes that may also affect the flow of air and oxygen 106 received by the cutting/welding torch.

The present invention therefore provides a removable device into the center hole of the cutting tip of a cutting/welding torch that can be easily cleaned without distorting future cuts, minimizes the amount of air and oxygen needed for a cutting or welding task, concentrates, controls and defines the flow of air and oxygen into a cutting/welding torch, prevents the center hole of a cutting/welding torch from becoming distorted and imprecise over time, improves the quality of a cut, and minimizes the amount of cut steel that must be cleaned up after a cutting/welding task is completed.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of concentrating, controlling and defining the flow of air and oxygen into a cutting/welding torch.

2. The method of claim 1, comprising the insertion of a removable device into the center hole of the cutting tip of said cutting/welding torch to concentrate, control and define the flow of air and oxygen into said cutting/welding torch.

3. The method of claim 2, wherein said removable device is metallic, has one flat end to facilitate insertion and removal of said removable device into or out of said center hole of said cutting/welding torch, and has one end that is neither flat nor straight and that concentrates, controls and defines the flow of air and oxygen into said cutting/welding torch.

4. The method of claim 3, wherein said end that is neither flat nor straight contains at least one twist, turn or bend.

5. The method of claim 3, wherein said end that is neither flat nor straight is shaped like a corkscrew.

6. A removable device that concentrates, controls and defines the flow of air and oxygen into a cutting/welding torch.

7. A removable device that is inserted into the center hole of the cutting tip of a cutting/welding torch to concentrate, control and define the flow of air and oxygen into said cutting/welding torch.

8. The device of claim 7, wherein said removable device is metallic, has one flat end to facilitate insertion and removal of said removable device into or out of said center hole of said cutting/welding torch, and has one end that is neither flat nor straight and that concentrates, controls and defines the flow of air and oxygen into said cutting/welding torch.

9. The device of claim 8, wherein said end that is neither flat nor straight contains at least one twist, turn or bend.

10. The device of claim 8, wherein said end that is neither flat nor straight is shaped like a corkscrew.
